(19) United States
(12) Patent Application Publication
(10) Pub. No.: US 2015/0121454 A1
(43) Pub. Date: Apr. 30, 2015

(54) VOIP AND UNIFIED COMMUNICATION AUTHENTICATION MECHANISM USING COMPONENTS OF THE SUBSCRIBER IDENTITY MODULE (SIM) AND RELATED HARDWARE AND FIRMWARE EQUIVALENTS IN MOBILE DEVICES.

(71) Applicant: Peter J. Cox, London (GB)

(72) Inventor: Peter J. Cox, London (GB)

(21) Appl. No.: 14/065,447

(22) Filed: Oct. 29, 2013

(51) Int. Cl. H04W 12/06

(52) U.S. Cl. CPC H04W 12/06
USPC 726/2

(57) ABSTRACT

The invention solves the problems associated with existing authentication and cryptographic systems used by Voice over IP (VoIP) and Unified Communication (UC) applications by providing a mechanism to enable VoIP and Unified Communication applications running on mobile devices, smart phones and tablets, to utilize software interfaces provided by the invention to perform the critical functions needed to authenticate and secure a VoIP or UC session. The invention performs these functions in a secure processing environment provided by the mobile device. Depending on the device type, the secure processing environment will be provided by the Secure Element component of a Subscriber Identify Mobile (SIM), by the Open TrustZone implemented on ARM chips, or by firmware included in the device. In each case the invention will interface with the secure processing environment using a published API providing low level access functions.

### RELATED APPLICATIONS

The present application is a continuation application of U.S. provisional patent application, Ser. No. 61/678,164, filed Aug. 1, 2012, for VOIP AUTHENTICATION MECHANISM USING SUBSCRIBER IDENTITY MODULE (SIM), by Peter Cox, included by reference herein and for which benefit of the priority date is hereby claimed.

### FIELD OF THE INVENTION

The present invention relates to the use of the Subscriber Identity Module (SIM) in mobile devices to provide an authentication service for VoIP and Unified Communication applications and, more particularly, to provide an interface between a Voice over IP (VoIP) or Unified Communication (UC) application to a component of the SIM capable of providing a secure processing environment or to a hardware or firmware subsystem providing an equivalent secure processing environment.

### BACKGROUND OF THE INVENTION

Voice over IP (VoIP) services including voice and video calls, and Unified Communications (UC) applications running on mobile devices, including smart-phones and tablet devices, must include the ability to provide authentication information before the service is used. Authentication typically occurs when the mobile device first connects to the service (registration), at intervals thereafter, when a new call is made, when a call is terminated and when an Instant Message (IM) is sent. The protocols driving VoIP and UC, for example the Session Initiation Protocol (SIP) specify robust mechanisms for authentication processing, but the requirements of these mechanisms mean that it is the mobile device which is authenticated and not the human user.

This limitation has clear disadvantages, there is limited security if a device is lost or stolen, calls made from a mobile device or an Instant Message sent from that device cannot be attributed to a human user and the existing authentication mechanism cannot establish non-repudiation of any communication sent from a mobile device.

The invention provides the following advantages:

1. The processing of protocol operations needed to provide identification, authentication and security functions needed to support a Voice over IP (VoIP) or Unified Communication Session is performed in a secure processing environment where those operations are immune from monitoring or tampering by malware and Trojan applications.

2. The processing of protocol operations needed to provide identification, authentication and security functions needed to support a Voice over IP (VoIP) or Unified Communication Session is performed in a secure processing environment which prevents identify information, device passwords, the intermediate results of authentication or cryptographic processing or private cryptographic keys being left in primary device memory where that information may be subsequently read by other applications where such access could lead to a security vulnerability.

3. The processing of protocol operations needed to provide identification, authentication and security functions needed to support a VoIP or Unified Communication (UC) Session becomes dependent on human intervention to authorize specific operations. This ensures that when VoIP and UC sessions are initialized and authenticated, the authenticated entity is the human user and not the device. This means that any VoIP or UC session (voice call, video call, instant message or presence update) is reliably attributed to the human user initiating that session. This in-turn provides auditable proof of the identity of the human user initiating a VoIP or UC session ensuring non-repudiation.

4. The processing of protocol operations needed to provide identification, authentication and security functions needed to support a VoIP or Unified Communication Session are performed in a way that reliably identifies the machine end-points of that session preventing a session compromise through a man-in-the-middle (MITM) attack.

### SUMMARY OF THE INVENTION

The invention solves the problems associated with existing authentication and cryptographic systems used by Voice over IP (VoIP) and Unified Communication (UC) applications by providing a mechanism to enable VoIP and Unified Communication applications running on mobile devices, smart phones and tablets, to utilize software interfaces provided by the invention to perform the critical functions needed to authenticate and secure a VoIP or UC session. The invention performs these functions in a secure processing environment provided by the mobile device. Depending on the device type, the secure processing environment will be provided by the Secure Element component of a Subscriber Identify Mobile (SIM), by the Open TrustZone implemented on ARM chips, or by firmware included in the device. In each case the invention will interface with the secure processing environment using a published API providing low level access functions.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a schematic view of a deployment of the invention showing the relationship between the major components;

FIG. 2 is a block diagram view of a showing the device api (dapi) components;

FIG. 3 is a flow chart view of a sequence of operations performed by a application to store user credentials in the secure processing environment via a sequence of device api (dapi) calls;

FIG. 4 is a flow chart view of a sequence of operations required for an application to respond to an authentication challenge including the necessary device api (dapi) calls;

FIG. 5 is a flow chart view of a sequence of device api (dapi) calls required to retrieve the necessary data required for an application to establish an encrypted Transport Layer Security (TLS)1 connection; and

FIG. 6 is a flow chart view of a device api (dapi) call required to request the generation of a session key by the secure processing environment in a form suitable for encrypting a VoIP media stream using the Secure Real-time Transport Protocol (SRTP)².

For purposes of clarity and brevity, like elements and components will bear the same designations and numbering throughout the Figures.

### DESCRIPTION OF THE PREFERRED EMBODIMENT

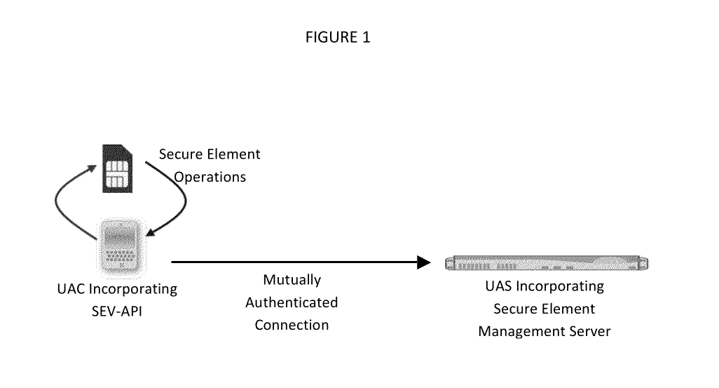

FIG. 1 is a schematic view of a deployment of the invention showing the relationship between the major components.

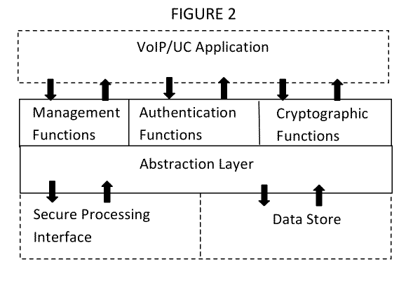

FIG. 2 is a block diagram view of a showing the device api (adpi) components.

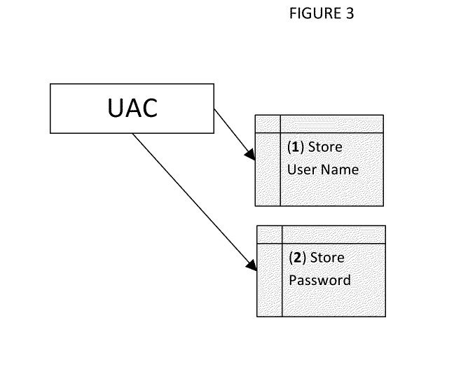

FIG. 3 is a flow chart view of a sequence of operations performed by an application to store user credentials in the secure processing environment via a sequence of device api (dapi) calls.

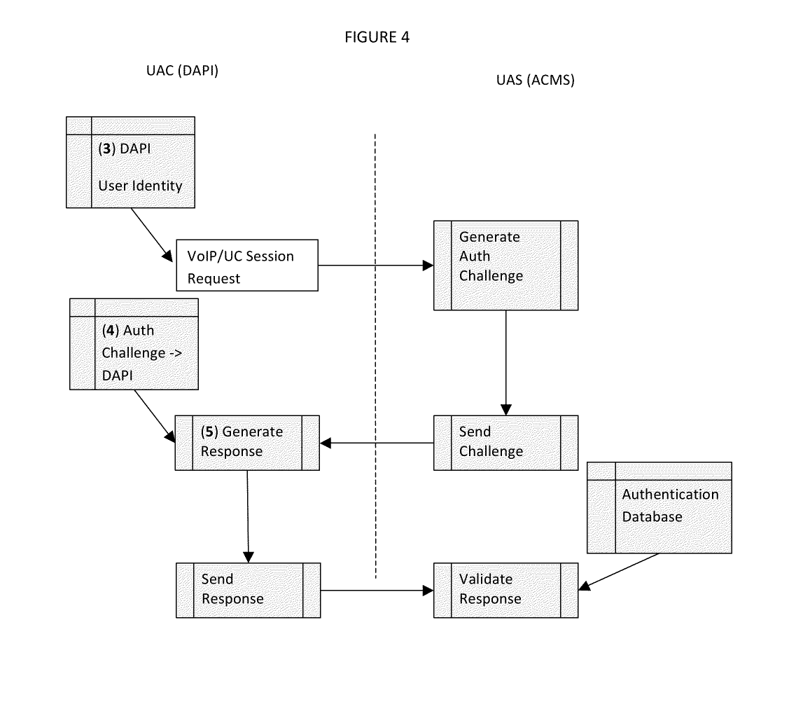

FIG. 4 is a flow chart view of a sequence of operations required for an application to respond to an authentication challenge including the necessary device api (dapi) calls.

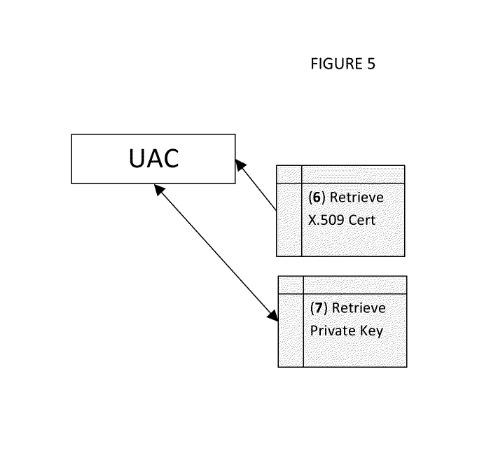

FIG. 5 is a flow chart view of a sequence of device api (dapi) calls required to retrieve the necessary data required for an application to establish an encrypted TLS connection.

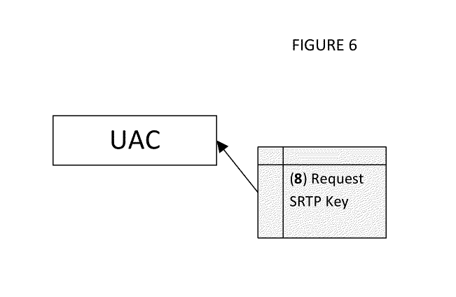

FIG. 6 is a flow chart view of a device api (dapi) call required to request the generation of a session key by the secure processing environment in a form suitable for encrypting a voip media stream using the secure real-time transport protocol (srtp).

The invention comprises two primary components.

1. A device API (DAPI) which runs on a mobile device providing an application programming interface (AIPI) for Voice over IP (VoIP) and Unified Communication (UC) applications for authentication and cryptographic processing.

2. An authentication and cryptographic management server (ACMS) which provides a network service enabling remote devices to connect to a VoIP or UC service, to authenticate to that service and to encrypt those connections using a mechanism that ensures that sensitive authentication and cryptographic processing is performed in the connecting device's secure processing environment.

The relationship between these components is shown in FIG. 1.

The device API (DAPI) comprises several subsections:

1. A set of functions exposed to VoIP or UC applications and callable by those applications. These functions are split into three groups.
a. Group 1 provides management functions.
b. Group 2 provides authentication functions.
c. Group 3 provides cryptographic functions.

2. An abstraction layer which provides the interface between the set of functions exposed to VoIP or UC applications and the underlying secure processing environment. The abstraction layer enables the use of multiple secure processing environments: Secure Element, a component of a Subscriber Identity Module (SIM), proprietary SIM processing environments with published interfaces, Open TrustZone developed by ARM, and hardware processing environments with published interfaces.

3. The secure processing interface and the Data Store. These components are specific to the secure processing environment used. Together they provide access to the secure processing environment's capabilities. The secure processing interface is used by the DAPI to pass processing requests to the secure processing environment, to include one or more parameters in that request and to obtain the results. The data store is a secure storage area within the secure processing environment where data may be stored in way that prevents subsequent reading, while making that data available to subsequent processing requests or stored in a form that may later be retrieved by a VoIP or UC application via a call to one of the exposed DAPI functions. The implementation details of the secure processing interface are dependent on the specific secure processing environment used.

FIG. 2 shows a block diagram of the device API components.

The group 1 functions (management) provided by the device API implement the following services.

1. User identity and authentication initialization. This set of services is used when a newly installed or newly configured VoIP or UC application running on a mobile device is first initialized. Data on the identity of the human user is stored in the secure processing data store in a form that may subsequently read and made accessible to the VoIP/UC application via an exposed function. The user's password is stored in the secure processing data store as write only data; it may not be read from the store but is available to be used in subsequent processing requests. Once the password is stored in the secure data store, the memory buffer holding this data is cleared. The user identity and password data may be obtained by the VoIP/UC application either by requesting direct user input or via a secure provisioning mechanism. The user must also provide some identifying data which will be required in subsequent interactions with the device API. The identifying data may be a simple PIN code or preferably biometric data uniquely identifying the user. The initial and subsequent collection of PIN codes or biometric data to be used as user indentifying information is outside the scope of this invention; this data will be collected by a operating service or through a 3rd party application. The mechanism used to obtain the configuration mechanism is outside the scope of this invention. All other services are implemented as callable functions within the device API.

2. Cryptographic initialization. This set of services is used to initialize the cryptographic environment. These services will be activated by a newly installed or newly configured VoIP or UC application immediately after user identity and authentication installation. The application makes a request to the device API to generate an X.5093 certificate request. The function implementing this request requires user identity and network domain information (in a form similar to an email address). This information is passed to the device API via a callable function. The device API generates an X.509 certificate request which is returned to the calling application and a private key which is stored in the secure processing data store as write only data; it may not be read from the store but is available to be used in subsequent processing requests.

3. Session initialization. This set of services is implemented as two functions. One function indentifies a secure API and returns an opaque handle which is used in subsequent interactions with the device API. The second establishes a connection to the secure processing environment. Establishing the connection requires that the human user provides the identifying data (PIN or biometric data) used in the user identification phase.

The group 2 functions (authentication) implement the following service.

1. Calculate authentication hash. This function takes a user name and a template, for example (user:authentication-realm:% p) and replaces the % p with the previously stored password for that user and returns a MD5 has for the resulting string. The password is obtained from the secure processing environment data store and the processing is completed within the secure processing environment in a way that prevents the password from being recovered by any application running on the device. The returned string is in a format suitable for completing the HTTP digest authentication processing used in VoIP and Unified Communication processing.

The group 3 functions (cryptographic) implement the following service.

1. Generate a cryptographically strong session key within the secure processing environment. The process uses environmental entropy to seed random number generators. The returned key will be suitable for use as a symmetric key to encrypt VoIP media sessions (voice or data streams). The key length will be specified by the calling application. The generated key is NOT stored within the secure processing environment. The key generation process is completed in the secure processing environment so that no application or operating system function on the devices is able to disrupt, modify or influence the process.

The Authentication and Cryptographic Management Server (ACMS) is a supporting service for mobile devices running the Device API (DAPI) in order to provide enhanced security for the authentication and encryption of VoIP or Unified Communication (UC) applications running on the mobile device. The ACMS provides a set of network services enabling devices running DAPI to complete the authentication process for a VoIP or UC session, to setup Transport Layer Security sessions to encrypt VoIP signaling connections and to accept Secure Real-time Transport Protocol (SRTP) connections to encrypt media sessions (voice or video). The majority of the network services provided by the ACMS are implemented according to published standards. These include:

1. User Identify and authentication services. The process of identifying a VoIP or UC user is implemented according to the specifications of the Session Initiation Protocol (SIP)⁴, using HTTP digest authentications.

2. Cryptographic functions. The required cryptographic services needed to provide Transport Layer Security (TLS) encrypted connections for VoIP signaling and UC applications including presence and Instant Messaging (IM) are implemented according to the specifications of the Transport Layer Security protocol1. Cryptographic services for encryption or media sessions (voice and video) are provided by the Secure Real-time Transport protocol (SRTP)².

The set of services comprising the Authentication and Cryptographic Management Server (ACMS) server may be provided on a VoIP or UC application server or on a suitable security gateway.

The operation of the invention is as follows:

A VoIP or Unified Communications (UC) app incorporating the Device API (DAPI) component of this invention is installed on a mobile device. For the purposes of this description the mobile device is termed a User Agent Client (UAC). The device is configured manually or through a provisioning service. When the VoIP or UC app running DAPI has the username and corresponding password these values are passed to a DAPI function call for storage. This process requires two function calls to the DAPI, see FIG. 3. The first function call, 1, stores the user identity. The second function call, 2, stores the password.

When the VoIP app running on the User Agent Client (UAC) connects to a VoIP or UC system providing the Authentication and Cryptographic Management Server (ACMS), which for the purposes of this description is termed a User Agent Server (UAS) it makes a number of calls to the Device API (DAPI) to complete the user identification and authentication process, see FIG. 4. The UAC first requests the user's identity from the DAPI, 3. This identity is used to construct a protocol connection request which is sent to the UAS. To authenticate the connecting user, the UAS sends an authentication request which includes a randomized challenge. This challenge together with the user's identity and the authentication realm (taken from the authentication request sent by the UAS) are passed to the DAPI as a request to generate the appropriate response, 4. A cryptographic hash of the supplied values together with the previously stored password is generated by the DAPI and returned to the calling app where this hash is combined with other elements from the authentication challenge to produce the authentication response, 5. This response is then sent back to the UAS. Assuming that the authentication response is valid, the UAS will grant the connection request.

When the VoIP app running on the UAC requires an encrypted TLS connection to a VoIP or UC service providing the Authentication and Cryptographic Management Services (ACMS) for the purposes of encrypting VoIP signaling, Presence Information or Instant Messaging. It retrieves credentials needed for this connection via the Device API, see FIG. 4. Two function calls are required, one to retrieve the X.509 certificate, 6, and one to retrieve the private key, 7.

When the VoIP app running on the UAC requires a session key for a Secure Real-time Transport Protocol (SRTP) protected media stream, the key is requested via the Device API, 8, see FIG. 5.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method for securing Voice over Internet Protocol (VoIP), Instant Messaging, Presence or unified communication sessions on mobile devices, the method comprising: an application programming interface (API) defining a set of operations to provide the security services.

2. A method for establishing the identity of a human user initiating a Voice over Internet Protocol (VoIP), Instant Messaging, Presence or Unified Communication (UC) sessions on mobile devices comprising: an application programming interface (API) defining a set of operations to provide the authentication service.

3. A method for constructing an application programming interface (API) to provide authentication services to software applications running on mobile devices comprising: an interface to secure processing environments on mobile devices provided the Secure Element component of SIMs (UICC or Universal Integrated Circuit Card) as defined by the SIM Alliance Open Mobile API6; an interface to secure processing environments on mobile devices provided by the Open Trust Zone7 implementation on ARM hardware; an interface secure processing environments implemented on System-on-a-chip Integrated Circuits providing secure processing environments8 for mobile devices.

4. The method of claim 3, further comprising: using an application programming interface (API) to store user identity and authentication credentials (password) in the secure processing environment.

5. The method of claim 3, further comprising: using an application programming interface (API) store the identity in a form that is readable by the software application, once the application has satisfied the access requirements of the secure processing environment.

6. The method of claim 3, further comprising: using an application programming interface (API) to store the authentication credentials in a form that cannot be subsequently retrieved from the secure processing environment.

7. A method for constructing an application programming interface (API) to process an HTTP Digest authentication as defined by RFC 26175 for software applications running on mobile devices comprising: an interface to secure processing environments on mobile devices provided the Secure Element component of SIMs (UICC or Universal Integrated Circuit Card) as defined by the SIM Alliance Open Mobile API6; an interface to secure processing environments on mobile devices provided by the ARM Trust Zone7; an interface secure processing environments implemented on System-on-a-chip Integrated Circuits providing secure processing environments8 for mobile devices.

8. The method of claim 7, further comprising: using the Application Programming Interface (API) to generate an authentication response to the HTTP Digest authentication challenge used to authenticate device registration, VoIP calls, video calls, Presence and IM transactions.
